(19) United States
(12) Patent Application Publication
(10) Pub. No.: US 2012/0005206 A1
(43) Pub. Date: Jan. 5, 2012

(54) APPARATUS AND METHOD FOR ANALYSIS OF DATA TRAFFIC

(76) Inventors: Konstantinos Anagnostakis, Singapore (SG); Spyridon Antonatos, Singapore (SG)

(21) Appl. No.: 12/526,495

(22) PCT Filed: Feb. 5, 2008
(86) PCT No.: PCT/SG2008/000040

§ 371 Date: Sep. 9, 2011

Related U.S. Application Data
(60) Provisional application No. 60/900,342, filed on Feb. 9, 2007.

(51) Int. Cl. G06F 17/30

(52) U.S. Cl. 707/737; 707/741; 707/E17.002

(57) ABSTRACT

An apparatus for defining an index in an index file representing a volume of traffic a computer system comprises a data processing module. The data processing module defines an index corresponding to a traffic data sequence and a first parameter of the traffic data sequence in a first record of the index file. An apparatus for evaluating a candidate signature representing a pre-determined class of traffic in a computing system compares a signature data sequence with entries in an index file and determines whether the candidate signature satisfies an evaluation criterion.

### REFERENCE TO RELATED APPLICATIONS

Reference is made to U.S. provisional patent application 60/900,342 filed 9 Feb. 2007 for an invention titled: Architecture and Algorithm for Signature Validation in Intrusion Detection and Prevention Systems, the contents of which are hereby incorporated by reference as if disclosed herein in their entirety, and the priority of which is hereby claimed.

### TECHNICAL FIELD

The invention relates to an apparatus and method for defining an index in an index file representing a volume of traffic in a computing system. The invention also relates to an apparatus and method for evaluating a candidate signature representing a pre-determined class of traffic in a computing system.

### BACKGROUND

In recent years significant progress has been made in computing system intrusion detection and prevention technologies. While these systems are capable of identifying novel attacks, especially worms, during the first minutes or even seconds of their appearance, it takes considerably much more time for security companies to distribute security updates with signatures of the new attacks. One key reason for this delay is that the signatures that these automated intrusion detection and prevention systems generate to block attacks may also block legitimate traffic in the computing system that is very similar to the attack traffic. When such blocks happens, the intrusion detection system is said to have returned “false positives” in that they return false results of finding attacks when the traffic blocked is in fact legitimate traffic. In order to avoid the possibility of this happening, network security companies are reluctant to deploy new signatures as security patches/updates to their customers without extensive validation and testing given the potentially severe consequences of the generated signatures causing denial of service for legitimate traffic. However, the validation procedure can be extremely time consuming, often resulting in great delays (with a duration of perhaps as much as days) between the attack being discovered and the signatures representing the attacks being distributed to customers.

Even the most effective attack detection infrastructure is meaningless without efficient means of reacting to the detected attacks. Discovery of a new vulnerability, whether through detection or through code reviews and other “offline” mechanisms is typically followed up by the distribution of software updates or patches. Present known techniques are found severely wanting in being able to react within an acceptable time frame to new attacks. The length of time required to develop, test and deploy these patches is significant, thus creating a bottleneck in the reactive defence lifecycle. Several existing approaches target this bottleneck. The intrusion detection industry is developing intrusion prevention systems that can block suspicious traffic using the most reliable detection heuristics available. Microsoft's™ Shield provides lightweight vulnerability specific filters that can be implemented on the end-host by intercepting and analysing incoming protocol messages. In both cases the signatures or filters to be distributed to users are reasonably small to be pushed quickly to a large number of sites, and much easier to compose than a permanent fully blown security update or patch. However, the inexact nature of these filters introduces the risk of accidentally blocking traffic containing bona fide, legitimate traffic. Although the accuracy of signatures can be tested, the process is time consuming. This technique may apply to non-attack signatures that are intended to characterize particular network applications, for example, P2P applications, which ISPs or enterprise may want to block or rate-control. For this purpose they use so-called Deep Packet Inspection (DPI) systems in a similar fashion with Intrusion Detection Systems.

### SUMMARY

The invention is defined in the independent claims. Some optional features of the invention are defined in the dependent claims.

A first disclosed technique allows for definition/representation of a volume of data traffic in an index file format. A second technique allows for the evaluation of a candidate signature defining a pre-determined class of traffic with respect to an index file representing a volume of data traffic.

The first technique allows a volume of traffic from a computing network to be represented in an efficient manner. An apparatus allowing definition of an index in an index file will allow creation of the index file to represent a volume of traffic in a computing system. The apparatus can be configured to receive the volume a representative volume of traffic representing traffic on a particular network/computing system and create the index file to represent that traffic. Manipulation and/or querying of the index file representing the traffic obviates the requirement to manipulate and/or query the huge volumes of the actual traffic data, which presents a significant time- and processing resource-intensive task. Further, the traffic may not actually need to be stored once an index file has been created, although, optionally, the traffic may be stored, whether locally in the apparatus, remotely or in a distributed network arrangement. One advantage arising from the use of the index file to represent the volume of data traffic is that after creation of the index file, algorithms which query the index file are indifferent to the actual traffic itself. Thus, storage of the traffic data afterwards is entirely optional. A particular user may choose to maintain the traffic for use later in querying the performance of the indexing algorithm.

In the second technique, the candidate signature is evaluated to determine its suitability as a proposed signature based on a determination of whether the candidate signature interferes with the data traffic in the computing system. This evaluation is carried out with respect to an index file representing the volume of traffic, rather than directly with respect to the volume of traffic itself. Thus a significant improvement in performance may be realised because of reduced processing time in querying the index, rather than the data itself. Because the acceptable range of false positive rates is quite small (for example, in the order of one false positive in every 10⁶ packets) the amount of traffic that needs to be analysed may be huge. Existing techniques provide only the option of analysing the traffic itself directly, requiring a significant amount of time to perform the analysis within the constraints of currently available processing technology. Thus, the disclosed techniques provide a real solution to the time lag between identification of an attack and deployment of security patches/updates designed to remedy the attacks.

Implementation of the disclosed techniques to evaluate a candidate signature with reference to an index file representing a volume of traffic allow a response time for the evaluation of less than one second, a response time which previously-known techniques are simply utterly incapable of providing.

The two principal techniques disclosed propose two phases which can be used either in conjunction with one another or separately: an offline phase where the traffic from a particular computing system (a trace of traffic) is processed to be defined by one or more entries in an index file (or an index file itself); and an online phase in which an algorithm evaluates a candidate signature with reference to entries in the index file.

### BRIEF DESCRIPTION OF DRAWINGS

The invention will now be described, by way of example only, and with reference to the accompanying figures in which:

FIG. 1 is a schematic diagram illustrating a signature evaluation/validation system;

FIG. 2 is a process flow diagram providing an overview of the disclosed techniques;

FIG. 3 is a block diagram illustrating an architecture for an apparatus for defining an index in an index file;

FIG. 4 is a process flow diagram illustrating a method of operation of the apparatus of FIG. 3;

FIG. 5 is a schematic diagram illustrating segmentation of traffic data sequences for use in the apparatus of FIG. 3;

FIG. 6 is a schematic diagram illustrating definition of an index file by the apparatus of FIG. 3;

FIG. 7 is a block diagram illustrating an architecture for an apparatus for evaluating a candidate signature;

FIG. 8 is a process flow diagram illustrating a method of operation of the apparatus of FIG. 7;

FIG. 9 is a schematic diagram illustrating the operation of the method of claim 8;

FIG. 10 is a graph illustrating a performance of the disclosed techniques; and

FIG. 11 is a graph illustrating the cumulative distribution function of index sizes for two volumes of data traffic.

### DETAILED DESCRIPTION OF PREFERRED EMBODIMENTS

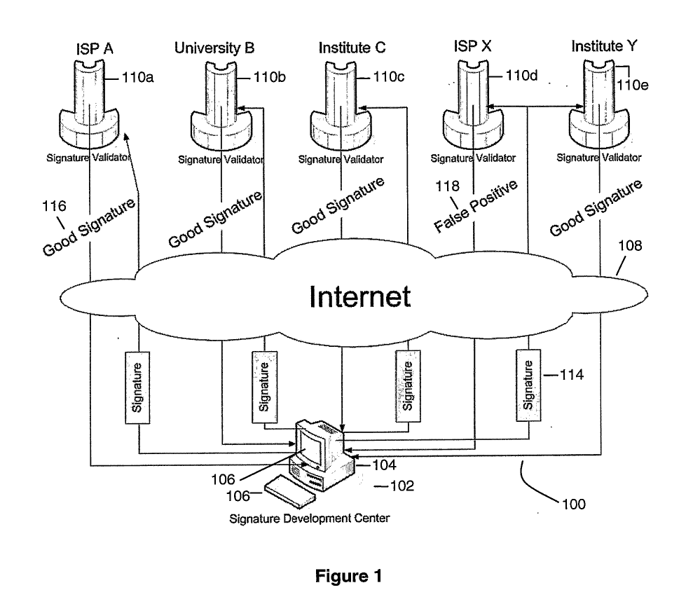

Referring first to FIG. 1, an overview of the disclosed techniques for signature evaluation/validation is illustrated. When, say, an internet security company wishes to validate a signature targeted to a customer's network, it may use the techniques disclosed herein to enjoy the guarantees that a candidate signature can be safely deployed over the network of, say, FIG. 1.

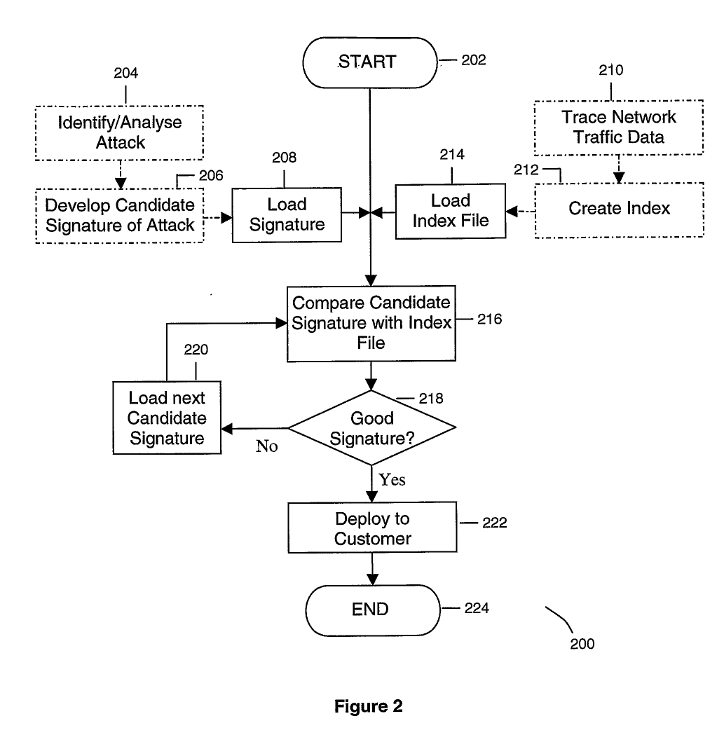

A computer network 100 comprises a signature development centre 102 at which a user may develop a signature to represent a pre-determined class of traffic in a computing system, for example, a security attack on a network. The user (not shown) develops a candidate signature representing the attack for evaluation with the disclosed techniques on the user computer apparatus 104 with user interface equipment 106. The development of the candidate signature is made in accordance with known techniques. Once developed, the candidate signature 114 is transmitted from the signature development centre 102 to computing systems (or computing sub-systems) at client networks/client workstations 110a, 110b, 110c, 110d, 110e over a network 108 such as the internet. As an example, ISP A 110a runs one or more evaluation algorithms (for example, the algorithms of FIG. 2 discussed below) on the candidate signature 114 and returns a result 116 of whether the candidate signature 114 is a good signature or not. In the example of FIG. 1, IPS A 110a returns the result 116 that the candidate signature is a good signature as it interferes with little or no traffic in the computing system of ISP A 110a. In the illustrated example, ISP X 110d runs the same algorithms with respect to trace traffic in computing system 110d, but ISP X 110d returns a result 118 that the candidate signature is not a good signature for computing system 110d when the signature interferes with “good” traffic in the computing system In this example, running of the algorithms of FIG. 2 at ISPX 110d indicates false positives in the system, meaning that an occurrence of the candidate signature in the legitimate data traffic of that system is flagged and that deployment of that signature in that network would cause denial-of-service to “good” traffic.

Alternatively, networks/workstations 110a, 110b, 110c, 110d, 110e transmit data pertaining to traffic in the network/workstation to signature development centre 102 for the evaluation of the candidate signature to be run on user computer apparatus 104. The data pertaining to traffic may be the actual traffic itself or, alternatively, a representation thereof derived using techniques disclosed herein, or in an alternative manner.

As a further alternative, the traffic may be monitored in a “distributed” fashion across the network of system 100. Ideally, if system 100 monitors all the traffic for a particular customer, it could guarantee a small percentage of false positives. However, due to privacy issues possibly customers may desire either to run the evaluation process themselves or to forward just a representative portion of its traffic. In that case, the accuracy of the system depends on how representative the traffic portion is.

False positives rates vary for different networks because false positives rates depend on traffic patterns. In order to determine that a signature is usable, an apparatus implementing these techniques uses knowledge of traffic of the target network. Furthermore, the more traffic the system captures for the target network, the higher the confidence will be that the given signature can be safely deployed or not.

For a given candidate signature one technique checks for an occurrence/match of the candidate signature in the index file representing traffic which is known to be legitimate traffic. By counting the number of matches it can derive a score for the signature. If that score is high (e.g. low false positive rate) it means that the candidate signature can be safely deployed on the target network. If the score is low (e.g. high false positive rate) it means that target network can expect legitimate traffic with the same or similar traffic characteristics as that of an attack. If the candidate signature were to be deployed on the target network, then Denial of Service (DOS) would probably result.

Therefore, best results will likely be obtained when a customer at, say ISP A 100a has provided traffic that is known to be attack free. Otherwise the system could produce an evaluation the candidate signature is not a good signature when in reality it would be safe to deploy.

One estimation provides that, in order for the signature validation techniques to work satisfactorily, the techniques should preferably have access to traffic in a computing system/network from a twenty-four hour period. However, this amount of traffic, for just a medium-sized organisation, is, frankly, enormous and requires a tremendous amount of storage without even considering the processing burden such a volume of traffic presents. Further, the disclosed techniques may very well be implemented in multiple networks. To avoid having to process this excessive amount of traffic, the use of an indexing approach to represent the traffic in the or each computing system/network incorporates time-space trade-off techniques to provide a significant saving in resources.

Additionally, a distributed approach may be implemented where the nodes of the distributed network store only a portion of the traffic of the customers and then cooperate to validate a signature.

Referring now to FIG. 2, a broad overview of the disclosed techniques is now provided. The specifics of the exemplary techniques are discussed in greater detail, but FIG. 2 provides a useful summary of the techniques.

The process 200 starts at step 202. The candidate signature for evaluation is loaded at step 208. In a separate or prior process, a pre-determined type of traffic is identified at step 204 and a candidate signature representing that class of traffic is developed at step 206. In the example of FIG. 2, the candidate signature represents a security attack on the computing system and the evaluation is made to determine the suitability of the candidate signature representing that attack for deployment on a target network. If the evaluation determines the candidate signature is not a good signature—e.g. it would interfere with legitimate traffic in the network/computing system—then the signature is not deployed for a security patch/update.

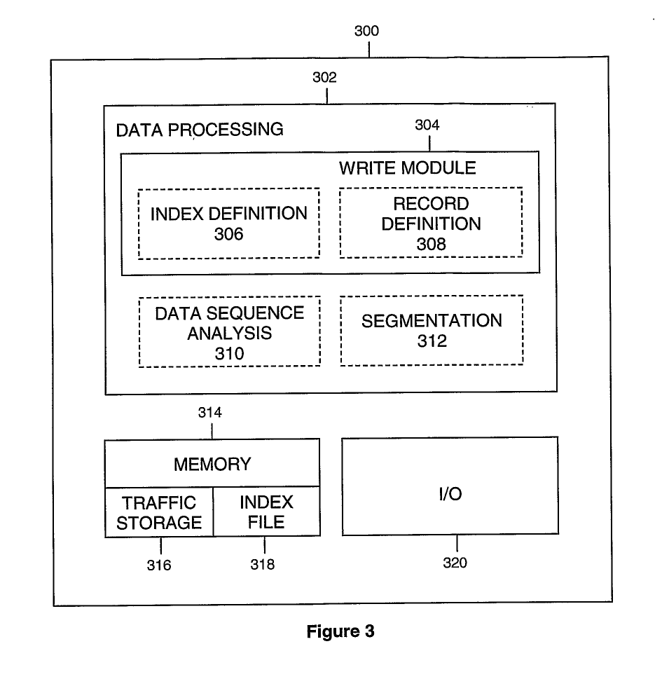

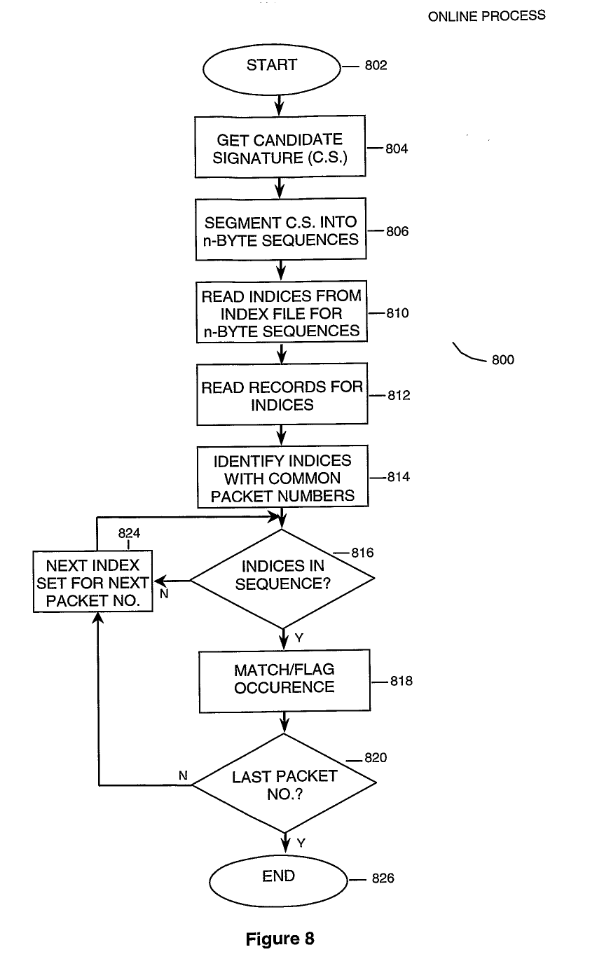

The candidate signature representing the attack is loaded to an evaluation algorithm at step 208. At step 214, an index file representing a volume of traffic in a network/computing system is loaded to the evaluation algorithm. This algorithm is described in more detail with respect to FIGS. 7 to 9. In a separate or prior process, the trace or sample network traffic data is retrieved at step 210 and the index file is created at step 212 for loading at step 214. This process is described in more detail below with respect to FIGS. 3 to 6.

At step 216, the candidate signature is compared with entries in the index file for evaluation of the candidate signature. At step 218, a determination of whether the candidate signature is a good signature or not is made. Upon determination the candidate signature is a good signature, the signature may be deployed to a customer at step 222 for use in a security patch/update of the customer's system. If the signature is determined not to be a good signature, a next candidate signature is optionally loaded for analysis at step 220. If this option is followed, the process loops around steps 216, 218, 220. One or more signature is deployed to a customer at step 222. The process ends at step 224.

An apparatus for definition of an index in the index file is now described with reference to FIG. 3. The apparatus may be used to create and/or build up an index file representing the traffic of a network/computing system.

The apparatus 300 for defining an index in an index file representing a volume of traffic in a computing system comprises a data processing module 302. Data processing module 302 comprises write module 304 which, in turn, comprises index definition module 306 and record definition module 308. Data processing module 302 also comprises data sequence analysis module 310 and segmentation module 312.

Alternatively, data processing module 302 is configured itself to perform the index definition and record definition functions of write module 304, along with the data sequence analysis 310 and segmentation 312.

As a further alternative, any of modules 304, 306, 308, 310, 312, are provided as separate, stand-alone modules within apparatus 300.

Apparatus 300 also comprises memory 314 configured to store traffic from the network and the index file in memory partitions 316, 318 respectively. Apparatus 300 also comprises module 320 for receiving the traffic for storage in memory 314, 316. Optionally, module 320 is an input-output module.

As will be illustrated, data processing module 302/index definition module 306 defines an index in the index file 318. The index corresponds to a traffic data sequence of the volume of traffic 316. Data processing module 302/record definition module 308 defines a first parameter of the traffic data sequence in a first record (not shown in FIG. 3) of index file 318. In one implementation, the index created/defined for the traffic data sequence corresponds with the first record; that is, the first record comprises information about the index and/or the traffic data sequence.

Data processing module 302/data sequence analysis module 310 determines a first parameter of the traffic data sequence as a first packet number of the traffic data sequence. Data processing module 302/record definition module 308 defines the first packet number of the traffic data sequence in the first record (not shown in FIG. 3) of index file 318.

Data processing module 302/data sequence analysis module 310 determines a sequence position of the traffic data sequence within the first packet. Data processing module 302/record definition module 308 defines the sequence position in the first record of the index file 318. Thus, in this example, the apparatus 300 defines two record fields of the record for the packet number and the position within the packet respectively.

Data processing module 302/record definition module 308 also defines a second packet parameter of the traffic data sequence with respect to a second packet of the traffic data sequence in a second record of the index file 318.

For reasons which will be made apparent below, segmentation module 312 segments the traffic data sequence of the data traffic into sub-sequences (n-byte sequences) of pre-determined length. Segmentation module 312 also creates respective index in the index file 318 for one or more of those sub-sequences.

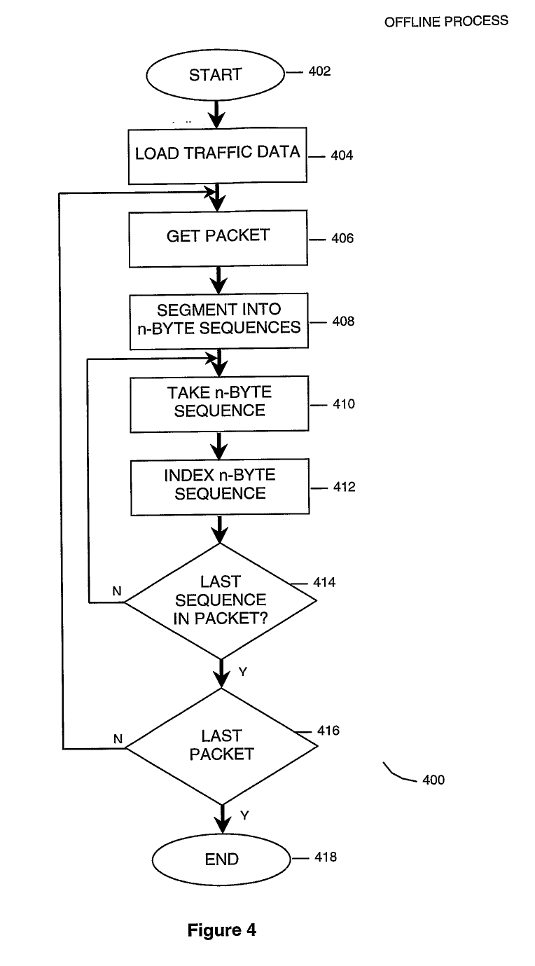

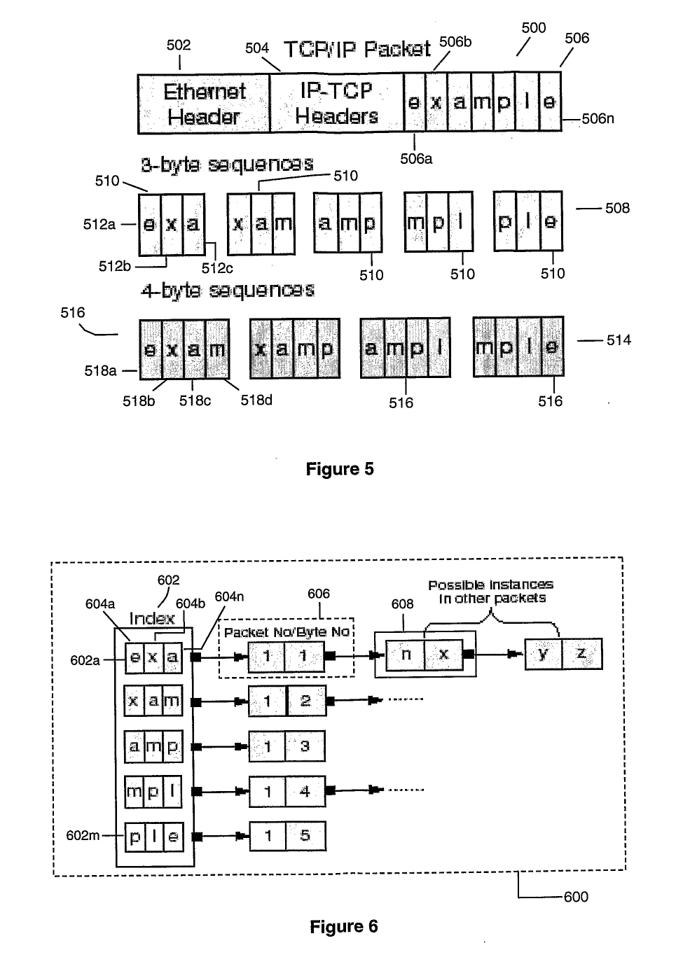

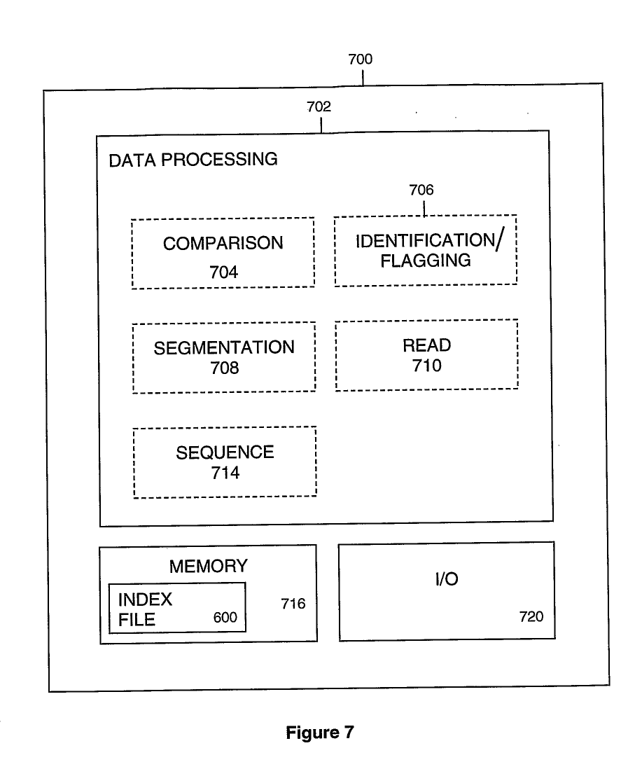

An overall process for operation of apparatus 300 is now described with reference to FIG. 4. Process 400 starts at 402. Traffic data 316 is loaded into memory 314 at step 404. At step 406 a packet of the traffic data 316 is retrieved/read from memory 314 for analysis. At step 408, segmentation module 312 segments the packet into n-byte sub-sequences. A first n-byte sequence is loaded for analysis at step 410 and is indexed at step 412 by data processing module 302/index definition module 306. This is described with reference to FIGS. 5 and 6. Data processing module 302/record definition module 308 defines the record for the index. At step 414, a determination is made as to whether the n-byte sequence indexed at step 412 is the last sequence in the packet. If n-byte sequence loaded at step 410 is not the last sequence to be analysed, the process loops around steps 410, 412, 414 until a determination is made that the last n-byte sequence in the packet has been indexed. At step 416, a determination is made as to whether the packet loaded at step 406 is the last packet for analysis. If more packets are to be analysed the process loops around step 406, 408, 410, 412, 414 and 416 until a determination is made that all packets have been analysed after which the process ends at step 418.

The segmentation of the packets into the n-byte sequences of the process of FIG. 4 are illustrated in greater detail in FIG. 5. A first packet 500 comprises an Ethernet header 502, IP-TCP headers 504 and bytes 506a, 506b, . . . , 506n of payload 506. Segmentation module 312 of apparatus 300 segments the payload 506 into a series 508 of 3-byte sequences (or “sub-sequences”) 510. Each of the 3-byte sequences 510 comprises bytes 512a, 512b, 512c . . . , etc. In the alternative, segmentation module 312 segments payload 506 into a series 514 of 4-byte sequences 516. Each 4-byte sequence 516 comprises bytes 518a, 518b, 518c, and 518d.

The indexing of the n-byte sequence at step 412 of FIG. 4 is now illustrated in greater detail with respect to FIG. 6. An index file 600 comprises a series 602 of indices 602a, 602b, . . . 602m. Each index 602a, . . . , 602m comprises (sub)sequence of bytes 604a, 604b, 604n. Each of the indices 602 are an index (of the traffic data sequences) as defined by data processing module 302/index definition module 306. For example, it is seen that index 604a “exa” corresponds to 3-byte sequence “exa” 510 of the traffic data sequence of FIG. 5. As set out above, data processing module 302/record definition module 308 defines a first parameter of the traffic data sequence in the first record 606. In this example, the first parameter of the traffic data sequence is defined as a first packet number of the traffic data sequence. n-byte sequence “exa” is found in packet 500 which is packet number 1 and data processing module 302/record definition module 308 defines this first traffic data sequence parameter by writing this to the first record 606 in index file 600 in memory 314. Data sequence analysis module 310 also determines the sequence position of the n-byte sequence “exa” within the first packet and writes this to record 606 of index file 600 in memory 314. In the example of FIG. 6, the sequence position defines the position within the packet of the n-byte sequence 602a; e.g. n-byte sequence “exa” in packet 500 is found at position 1 in the payload 506 of packet 500. Additionally, apparatus 300 may, through data sequence analysis module 310 and record definition module 308, define a second parameter of the traffic data sequence with respect to a second packet in a second record 608 of the index file 600.

Thus an index file 600 may be made up indices and records defined by apparatus 300 and stored in partition 318 of memory 314.

Broadly speaking, in the “offline” phase algorithm 400 is able to index every n-byte sequence appearing in the traffic captured/transmitted by a customer from its network. For every appearance of each n-byte sequence a six-byte record is kept: four bytes for the packet number in which the sequence was found (e.g. the packet number defining the order in which the packets are received at apparatus 300) and two bytes for the position of the n-byte sequence within the packet. Thus, an advantage the algorithm of FIG. 4 is that it is necessary only to retrieve the information stored on the index, eliminating the need to perform a search on (or other manipulation of) the captured traffic itself. Thus, the size of information for each sequence should, preferably, be as little as possible. By increasing “n” the information stored for each sequence is reduced but the number of sequences to be indexed increases. For example, choosing 1 as n, 256 indices are created but each index is several megabytes (assuming a 1 GB input trace). Choosing 4 as n, each index contains a few records, but 2³² indices.

In one implementation, apparatus 300 stores the indices 602a, 602b . . . 602m in memory 318, 314 in an identifiable manner so they can be easily retrieved and/or referred to by the online process described with reference to FIGS. 7 to 9.

Referring first to FIG. 7 an architecture of an apparatus 700 for evaluating a candidate signature representing a pre-determined class of traffic in a computing system is illustrated. The apparatus 700 comprises a data processing module 702, a memory 716 and a module 720, which in the example of FIG. 7 is an input-output module. Apparatus 700 also comprises a comparison module 704, an identification/flagging module 706, a segmentation module 708, a read module 710, and a sequence module 714. Apparatus 700 may be configured for data processing module to perform the functionality of modules 704, 706, 708, 710, 712, 714 or these modules may be provided as separate, stand-alone modules within apparatus 700.

Memory 716 stores index file 600 which may be defined in a separate process (such as the process of FIG. 4) and received through module 720. Alternatively the apparatus 700 is also configured to perform the process of FIG. 4.

As noted, in this example, the candidate signature is a signature representing a security attack on a computing system. The candidate signature comprises a signature data sequence as will be described below. Data processing module 702/comparison module 704 compares the signature data sequence with entries in the index file 600 stored in memory 716 and makes a determination as to whether the candidate signature satisfies an evaluation criterion. In this example, data processing module 702/identification module 706 determines whether the candidate signature satisfies the evaluation criterion in dependence of whether the comparison of the signature data sequence with the entries in the index file flags an occurrence of the signature data sequence in the volume of traffic. Data processing module 702/segmentation module 708 segments the signature data sequence of the candidate signature into sub-sequences (n-byte sequences) with respect to indices in the index file as will be described in more detail below. Data processing module 702/read module 710 reads indices from the index file 600 corresponding to sub-sequences of the signature data sequence. Additionally, read module 710 reads records of the read indices.

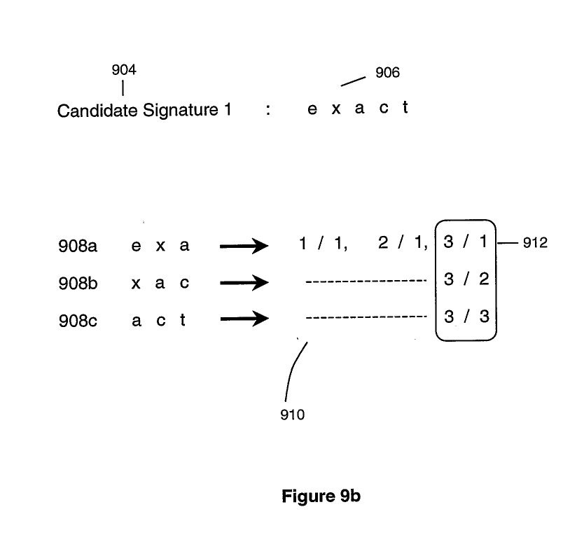

Data processing module 702/identification module 706 identifies a common record parameter amongst records which have been read by reader module 710. In one implementation, the common record parameter is a common packet number for a plurality of the records. This is described with reference to FIG. 9.

Also as described in more detail in FIG. 9, data processing module 702/sequence module 714 determines whether the records having a common record parameter comprise a sequence of records. In the implementation described below, this is a determination of whether the sequence of records corresponds to the subsequence of the candidate signature.

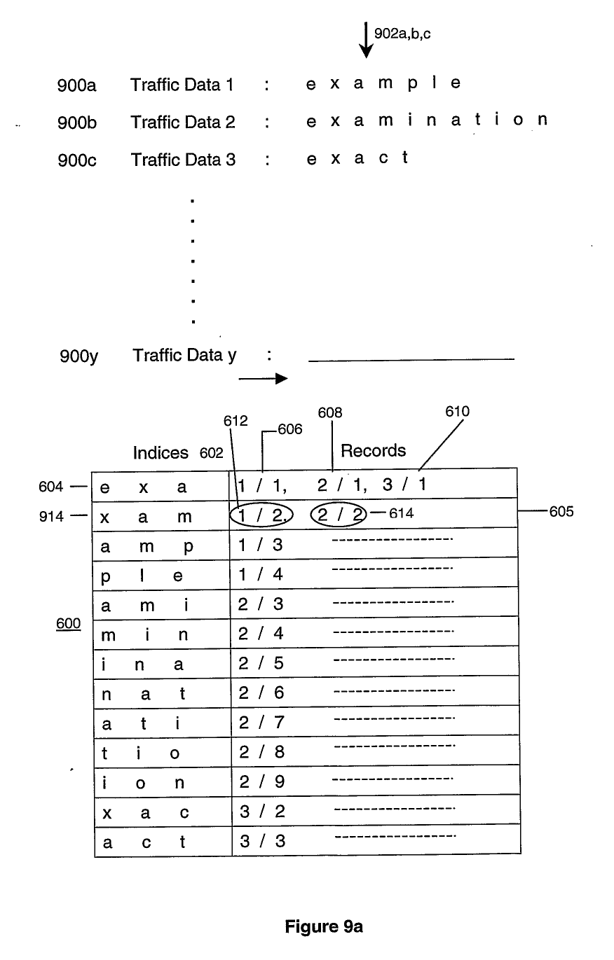

A process flow of operation of the apparatus of FIG. 7 is described in detail on FIG. 8. The process 800 starts at step 802 after which a candidate signature for evaluation is loaded at step 804. At step 806, segmentation module 708 segments the candidate signature into n-byte sequences (sub-sequences) corresponding to indices in the index file. This may mean that the candidate signature is segmented into sequences which are to be found in the index and/or the candidate signature is segmented into sequences of the same length as the indices (i.e. having the same number n of bytes in the n-byte sequence). At step 810, reader module 710 reads indices from the index file 600 for the n-byte sequences created by step 806. At step 812, reader module 710 reads the records for the indices from index file 600. At step 814, identification module 706 identifies the indices with a common record parameter which, in the present example, is common packet numbers. At step 816, sequence module 714 determines whether the indices having a common packet number define a sequence. If the records of the indices do not define a sequence, the next index set for the next packet number is loaded at step 824 and checked at step 816. When a determination that the indices are in sequence is made at step 816, a flag of an occurrence of the signature data sequence in the volume of traffic is made at step 818. Following this, at step 820, apparatus 700 determines whether the last packet number has been reached and, if not, the process loops around steps 816, 818, 820, 824 until the process ends at step 826.

Thus, the “online” phase performs matching based on the information stored in the indices and records. Initially, the indices for the n-byte sub-sequences that form the pattern of the signature are retrieved. The retrieved information is then analysed to find packets in which all sub-sequences are found and their positions are adjacent. In one implementation, an index of a first subsequence is compared with an index of a second subsequence. Then, all six-byte records are checked to identify those that have a common packet number. For instance, if a record of first index indicates that the first subsequence is found in packet A and packet A does not appear in the records of the second index, then this record is dropped. For the records that have the same packet number, positions are checked to determine whether they are in a sequence. If in the first index there is a record saying “packet A position B”, then the algorithm checks to find if there is a record in second index that says “packet A position B+1”. If such a record is found then the record of the second index is checked against the index of the third subsequence in order to locate a record “packet A position B+2” and so on. If the checks are successful up to the index of the last subsequence, then a match in packet A at position B is identified.

The analysis, identification and sequence determination process steps 810, 812, 814 and 816 are now described in greater detail with respect to FIG. 9.

FIG. 9 illustrates traffic data sequences 900a, 900b, 900c. For example, first traffic data sequence 900a comprises a sequence 902a of bytes as illustrated. Second traffic data sequence 900b comprises a series 902b of bytes and third traffic data sequence 900c comprises a sequence 902c of bytes.

Index file 600 comprises a series 602 of indices 604 as defined in, say, the process of FIG. 4. Also illustrated is a series 605 of records comprising records 606, 608, 610 defined by that process. For example record 606 defines that the index defined by 3-byte sequence “exa” 604 is found in first packet 900a at the first position. Record 608 defines that index 604 is also found in second packet 900b at position 1. Finally, record 610 defines that index 604 is found in third packet 900c at packet position 1. Also as illustrated records 612 and 614 illustrates, respectively, that index 906 (“xam”) is found in first packet 900a at position 2 and second packet 900b at position 2.

Segmentation module 708 takes candidate signature 904 comprising sequence 906 of bytes and segments this signature data sequence into n-byte sub-sequences with respect to indices in the index file. For example, the signature data sequence “exact” is segmented into first 3-byte sequence 908a “exa”, second 3-byte sequence 908b ‘xac” and third 3-byte sequence 908c “act”. The reader module 710 reads from index file 600 the group of records 910 corresponding to the indices 604 from the index file which, in turn, correspond to 3-byte sequences 908a, 908b, 908c. Identification module 706 identifies the subset of records 912 from the group of records 910 which has a common record parameter, in this record a common packet number “1”. This identifies that the n-byte sequences of candidate signature 904 are found in a common packet of the traffic data indexed and represented by index file 600. Sequencing module 714 determines whether the records 912 run in the sequence 3/1, 3/2 and 3/3. When sequence module determines that the records run in sequence, a match is flagged and identification of an occurrence of the candidate data signature sequence within the volume of traffic is identified.

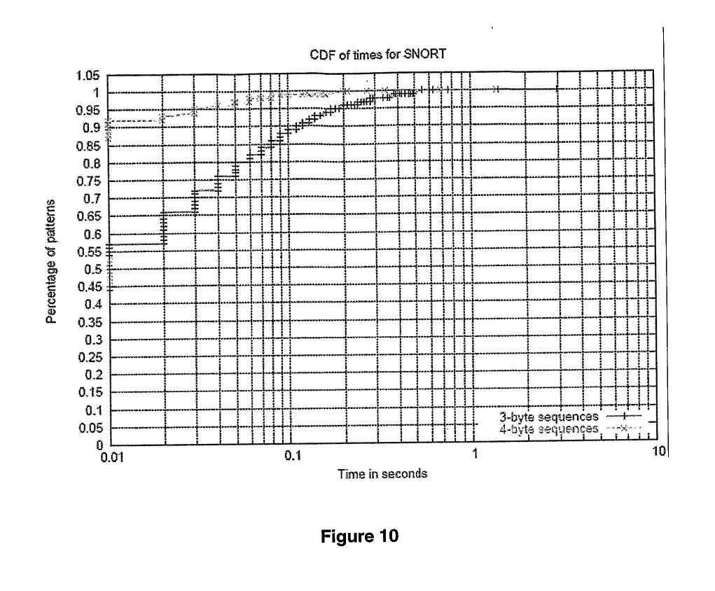

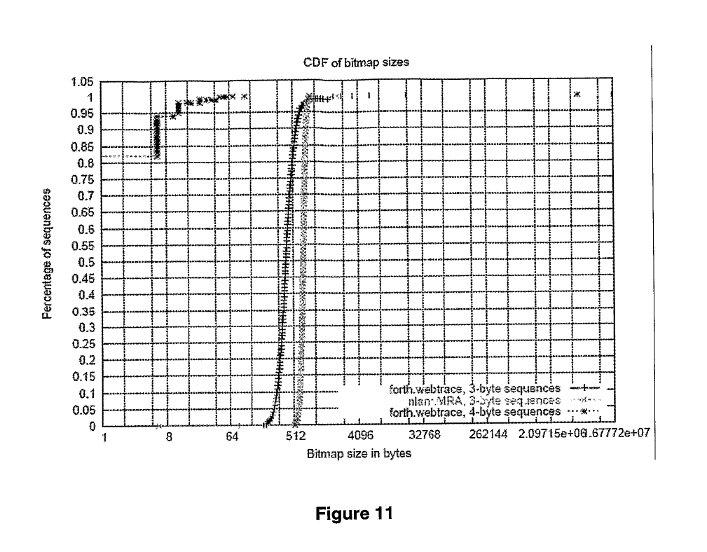

An evaluation of the techniques disclosed is performed by validating the signatures found on Snort, a popular intrusion detection system, on a trace containing 3 Gbytes of captured traffic. The results for 3- and 4-byte sequences are summarised in FIG. 10. For almost 95% patterns tested, the techniques achieve sub-second search time. The preliminary results also indicate that hotspots presented in the remaining 5% of patterns are one to two orders of magnitude more effective than traditional linear searches. The dominant cost of the approach is the size of the indices retrieved. The size of each index for two traces is presented in FIG. 11. Both traces contain 3 GBytes of data. FORTH.webtrace is a trace captured during a portal mirroring and Nlanr.MRA is a trace with random payload. For almost 95% of sequences, up to 1 Kbyte is retrieved, although the maximum value reaches 16 Mbytes due to some popular sequences like consecutive zeros found in JPEG images. In the ideal case, this of random payload, each index is 500 to 900 bytes long. As the data retrieved from disk is only a few kilobytes for the 3 GBytes trace, it is expected that time for searching on Terabyte traces is also near one second. Either fetching a few Kilobytes or a few Megabytes (e.g. less than 20 MB) from a local hard disk requires almost the same time.

Finally, for comparison purposes Snort was used to validate some of its own signatures. According to the measurements Snort required around 80 seconds to validate a signature on a 3 Gbytes trace. Doing the same validation with the disclosed techniques the algorithm takes around 1 second for 80% of the possible patterns.

Distributed signature validation enables security companies to very quickly get feedback from their customers about the quality of a candidate signature reducing this way the time between a signature is found and a security update is disseminated to the customers. The high performance algorithm enables the required checks for the validation of the candidate signatures to be performed rapidly on large datasets, in order to reduce the statistical probability of false positives.

Although the above examples have been given with a view to analysis to a payload of a data packet, The same techniques can be applied to index header fields, such as IP addresses or TCP/UDP ports.

It will be appreciated that the apparatus disclosed herein may be, say, one or more computer apparatus. The various techniques disclosed may be implemented in hardware, software or a combination thereof.

It will be appreciated that the invention has been described by way of example only and that variations in detail may be made without departure from the spirit and/or scope of the appended claims.

1-19. (canceled)

20. Apparatus for defining an index in an index file representing a volume of traffic in a computing system, the apparatus comprising a data processing module configured
to define the index, the index corresponding to a traffic data sequence of the volume of traffic, the traffic data sequence having a predetermined length; and
to define a first record for the index in the index file, the first record comprising a first parameter of the traffic data sequence.

21. Apparatus according to claim 20, wherein the apparatus comprises a traffic data sequence analysis module configured to determine the first parameter of the traffic data sequence as a first packet number of the traffic data sequence, the apparatus being configured to define the first packet number in the first record.

22. Apparatus according to claim 21, wherein the first record further comprises a second parameter of the traffic data sequence, and the traffic data sequence analysis module is configured to determine the second parameter of the traffic data sequence as a sequence position within the first packet, the apparatus being configured to define the sequence position in the first record.

23. Apparatus according to claim 20, wherein the apparatus is configured to define a second record for the index in the index file; the second record comprising parameter(s) of the traffic data sequence with respect to a second recurrence of the traffic data sequence in the volume of traffic.

24. Apparatus according to claim 20, wherein the apparatus comprises a segmentation module configured to segment the traffic data sequence into subsequences of pre-determined length and to create respective indices for the subsequences.

25. Apparatus according to claim 20, the apparatus being further configured to evaluate a candidate signature representing a pre-determined class of traffic in the computing system, the candidate signature comprising a signature data sequence, wherein the data processing module is configured to:
compare the signature data sequence with entries in the index file; and
determine whether the candidate signature satisfies an evaluation criterion.

26. Apparatus according to claim 25, wherein the data processing module is configured to determine whether the candidate signature satisfies the evaluation criterion in dependence of whether the comparison of the signature data sequence with entries in the index file flags an occurrence of the signature data sequence in the volume of traffic.

27. Apparatus according to claim 25, wherein the apparatus comprises a segmentation module configured to segment the signature data sequence of the candidate signature into subsequences with respect to indices in the index file.

28. Apparatus according to claim 27 wherein the apparatus comprises a read module configured to read indices from the index file corresponding to subsequences of the signature data sequence.

29. Apparatus according to claim 28, wherein the read module is configured to read records of the read indices.

30. Apparatus according to claim 29, wherein the data processing module is configured to identify a common record parameter amongst records of the read indices.

31. Apparatus according to claim 29, wherein the apparatus comprises a sequence module for determining the read records having the common record parameter comprise a sequence of records.

32. Apparatus for evaluating a candidate signature representing a pre-determined class of traffic in a computing system, the candidate signature comprising a signature data sequence, wherein the apparatus comprises a data processing module configured to:
compare the signature data sequence with entries in an index file, the index file representing a volume of traffic in the computing system, each entry comprising:
an index, the index corresponding to a traffic data sequence of the volume of traffic, the traffic data sequence having a predetermined length; and
a first record for the index in the index file, the first record comprising a first parameter of the traffic data sequence; and
determine whether the candidate signature satisfies an evaluation criterion.

33. Apparatus according to claim 32, wherein the data processing module is configured to determine whether the candidate signature satisfies the evaluation criterion in dependence of whether the comparison of the signature data sequence with entries in the index file flags an occurrence of the signature data sequence in the volume of traffic.

34. Apparatus according to claim 32, wherein the apparatus comprises a segmentation module configured to segment the signature data sequence of the candidate signature into subsequences with respect to indices in the index file.

35. Apparatus according to claim 34, wherein the apparatus comprises a read module configured to read indices from the index file corresponding to subsequences of the signature data sequence.

36. Apparatus according to claim 35, wherein the read module is configured to read records of the read indices.

37. Apparatus according to claim 36, wherein the data processing module is configured to identify a common record parameter amongst records of the read indices.

38. Apparatus according to claim 37, wherein the apparatus comprises a sequence module for determining the read records having the common record parameter comprise a sequence of records.

39. A method of defining an index in an index file representing a volume of traffic in a computing system, the method comprising
defining the index, the index corresponding to a data sequence of the volume of traffic, the traffic data sequence having a predetermined length; and
defining a first record for the index in the index file, the first record comprising a first parameter of the traffic data sequence.

40. The method of claim 39, the method further comprising evaluating a candidate signature representing a pre-determined class of traffic in the computing system, the candidate signature comprising a signature data sequence, the method comprising:
comparing the signature data sequence with entries in the index file; and
flagging an occurrence of the signature data sequence in the volume of traffic.

41. A method of evaluating a candidate signature representing a pre-determined class of traffic in a computing system, the candidate signature comprising a signature data sequence, the method comprising:
comparing the signature data sequence with entries in an index file, the index file representing a volume of traffic in the computing system, each entry comprising
an index, the index corresponding to a traffic data sequence of the volume of traffic, the traffic data sequence having a predetermined length; and
a first record for the index in the index file, the first record comprising a first parameter of the traffic data sequence; and
determining whether the candidate signature satisfies an evaluation criterion.

42. A method of creating an index in an index file representing a volume of traffic in a computing system using the apparatus of claim 20.

43. A method of evaluating a candidate signature representing a pre-determined class of traffic in a computing system using the apparatus claim 32.

44. A computer program product having computer program code stored thereon comprising executable instructions for implementing the method of claim 39.
